(19) United States
(12) Patent Application Publication
(10) Pub. No.: US 2016/0185317 A1
(43) Pub. Date: Jun. 30, 2016

(54) Vehicle Child Safety Device (VCSD)

(71) Applicant: Justin Bambico, Farmersville, TX (US)

(72) Inventor: Justin Bambico, Farmersville, TX (US)

(21) Appl. No.: 14/863,623

(22) Filed: Sep. 24, 2015

Related U.S. Application Data
(60) Provisional application No. 62/054,998, filed on Sep. 25, 2014.

(51) Int. Cl. B60R 22/48

(52) U.S. Cl. CPC B60R 22/48; B60R 2022/4883; B60R 2022/4808; B60R 2022/4866

(57) ABSTRACT

A vehicle safety child device to detect a child left unattended in a vehicle may include a circuit to receive a location signal from a satellite; a circuit to receive audio signals from the interior of a vehicle; a circuit to connect to a control circuit of the vehicle; and a cellular circuit to activate a cellular signal to a cellular antenna. An alarm is activated when the audio signal exceeds a predetermined level.

### FIELD OF THE INVENTION

The present invention relates to a child safety device and more particularly to a child safety device to prevent overheating in a vehicle.

### BACKGROUND

A vehicle which has been turned off and with the windows rolled up may very quickly reach high temperatures especially during the summer time. As a consequence, children may die as a result of being left unattended in a vehicle in one of three ways:
52%—Child was “Forgotten” by caregiver
29%—Child was playing in an unattended vehicle and became trapped
18%—Child is intentionally left alone

Children are at the great risk for heatstroke because a child's body heats up 3-5 times faster than an adult. When the body's temperature reaches 104 degrees, the internal organs start to shut down. When it reaches 107 degrees, the child can die. Additionally, small children may not be able to open the door to escape the hot conditions.

Heatstroke, also known as hyperthermia, is a condition that occurs when the body isn't able to cool itself quickly enough, and the body temperature rises to dangerous levels.

Since 1998, more than 550 children across the United States have died from being trapped in a hot car. An average of 38 children die every year, and for every child who dies, hundreds more are rescued. It does not have to be hot outside for the car to heat up to a dangerous level. Light pouring through the windows of the cars stays within the car and raises its temperature.

Furthermore, heatstroke is not the only danger of a child left in a vehicle. Children can put a car in gear, wander away from the car or be kidnapped.

### SUMMARY

A vehicle safety child device to detect a child left unattended in a vehicle may include a circuit to receive a location signal from a satellite; a circuit to receive audio signals from the interior of a vehicle; a circuit to connect to a control circuit of the vehicle; and a cellular circuit to activate a cellular signal to a cellular antenna.

An alarm is activated when the audio signal exceeds a predetermined level.

The alarm may be a light flasher on the vehicle.

The alarm may be a cellular signal to broadcast the location of the vehicle.

The alarm may activate a horn of the vehicle.

The alarm may activate the control circuit to roll down the windows of the vehicle.

A first LED light may be activated when the audio signal does not exceed a predetermined level.

A second LED light may be activated when the audio signal exceeds the predetermined level.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the vehicle Child safety device of the present invention;

FIG. 2 illustrates a circuit diagram of the vehicle Child safety device of the present invention;

FIG. 3 illustrates a perspective view of another embodiment of the vehicle Child safety device of the present invention;

FIG. 4 illustrates a circuit diagram of the vehicle Child safety device of the present invention.

### DETAILED DESCRIPTION

The “Vehicle Child Safety Device” or “VCSD” includes a vehicle sensor unit that will help prevent the death or serious injury to children and infants that become trapped or abandoned inside a vehicle while it is not a being operated.

The functions of the present invention or the “Vehicle Child Safety Device” or “VCSD” may include a plastic housing unit that connects to the vehicle for example the electrical system of the vehicle through one of two ways: On-board diagnostics, an electronics self diagnostic system, typically used in automotive applications OBD2 Port or a 12V Auxiliary Outlet, which will also serve as power for the device. Once connected to the vehicle, the present invention “VCSD” may include a microphone to capture sounds inside the parked vehicle and determine if the sounds reach a predetermined Db level equal to , greater than or corresponding to a child crying. Once the predetermined Db level is reached, the “Vehicle Child Safety Device” will simultaneously activate a series of safety procedures to draw attention to the vehicle and the child and to summon help.

The first safety procedure would be to activate the exterior lights of the vehicle through the vehicles current electrical circuitry, and the exterior lights are activated to start flashing to help draw attention to the vehicle which will help with the early rescue of a child that has become trapped or abandoned. The flashing lights will also serve as an identification signal for rescue services to look for to help locate the vehicle.

The second safety procedure would be to place an emergency call to 911 through a cellular signal. Once the dispatcher receives the call they can dispatch the necessary rescue services. At this point, the call can be triangulated and GPS coordinates can be sent to the dispatcher and Rescue Services. Once the call has been placed to the 911 dispatcher, the third safety procedure can start.

The third safety procedure would be to activate the horn of the vehicle through the vehicles current electrical circuitry and make it start honking. This will aid not only with early rescue but it will also serve as a locating signal for emergency services.

Even though most parents and guardians are more than capable of keeping up with where their children may be at all times we hear all too often that a child has died or suffered severe injury from being trapped or abandoned in a parked vehicle. The “Vehicle Child Safety Device” will help parents and guardians know for sure that if for some reason one of their children do become trapped or forgotten in an overheated vehicle during our hectic schedules, Rescue Services will be dispatched promptly to rescue the children. With three different safety procedures, the possibility of a timely rescue from either bystanders or Emergency Services is greatly enhanced.

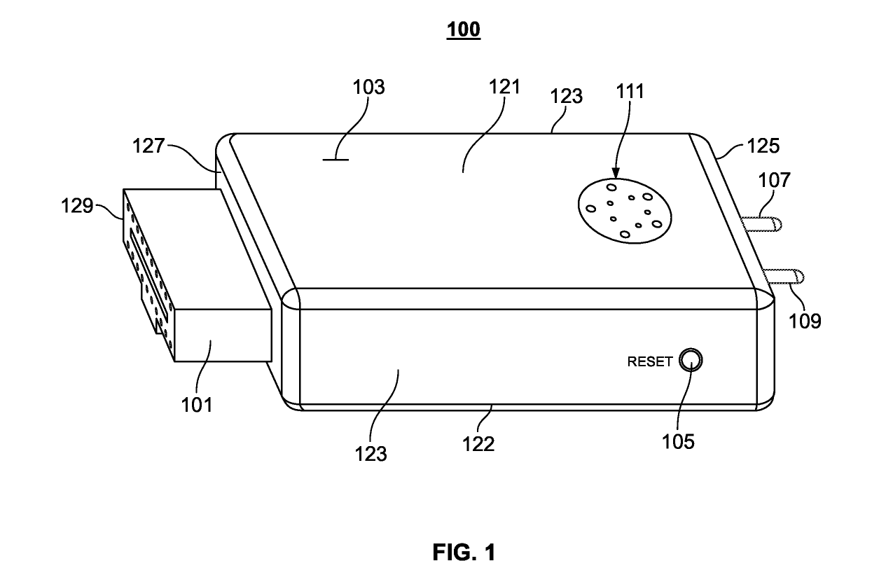

FIG. 1 illustrates the vehicle Child safety device 100 of the present invention and illustrates a generally rectangular device which may be formed from plastic, metal or other suitable material. The vehicle Child safety device 100 may include a top surface 121, an opposing bottom surface 123 which opposes the top surface 121, a pair of opposing side surfaces 122 which connect the top surface 121 and the bottom surface 123, a back surface 125 and a front surface 127 which may have a connector 129 to connect to the control circuit which controls the various functions of the vehicle. The connector 129 may be an OBD2 connector to connect to the electrical system of the vehicle.

The top surface 127 may include a microphone 111 to obtain the level of sounds within the vehicle, a first LED light 107 which may indicate insufficient sounds within the vehicle to activate the alarms, a second LED light 109 to indicate that the sound level has surpassed a predetermined level of sounds to activate the alarms of the present invention, and a reset switch to reset the device. The first LED light and the second LED light may extend out of the back surface 125, and the reset button (switch) may extend out of the side surface 122.

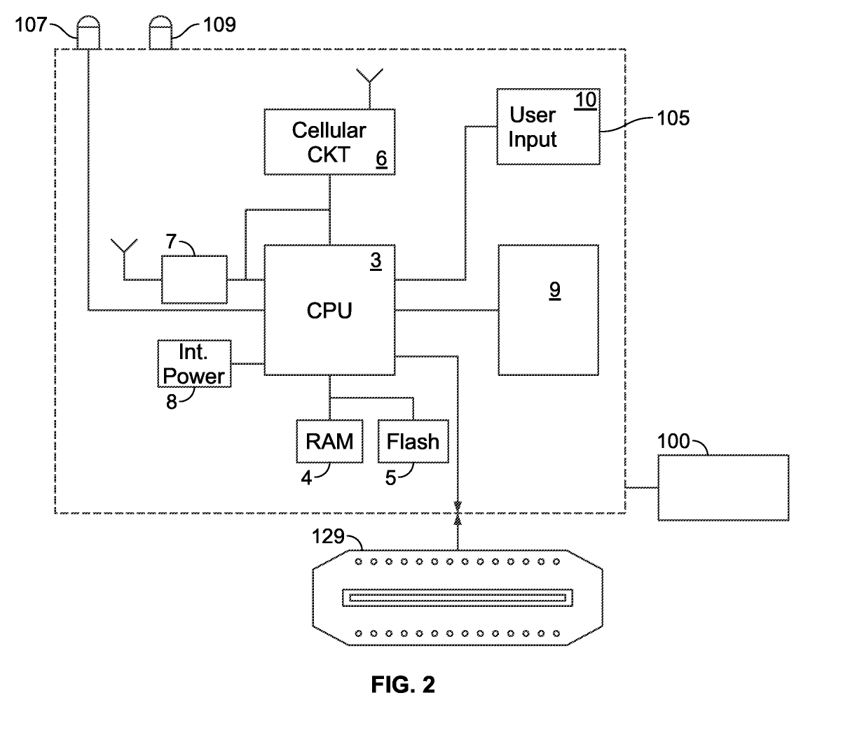

FIG. 2 illustrates a circuit diagram of the present invention and illustrates that the connector 129 is connected to the CPU circuit 3 (central processing unit circuit) which may activate either or both the first LED light 107 and the second LED light 109 to indicate various conditions such as the device 100 is activated or the device 100 is activated to an alarm condition when the sounds from the microphone 111 exceeds a predetermined level. An internal battery 8 supplies power to the CPU circuit 3 or other circuit which may require power, and the CPU circuit 3 may be connected to the reset switch 105 to allow the user to reset the CPU circuit 3. The CPU circuit 3 receives a location signal from the GPS circuit 7 (global positioning satellite circuit) to obtain the physical location of the device 100, and the physical location may be stored within the RAM circuit 4 by CPU circuit 3. After the microphone 111 receives an audible sound greater than the predetermined level, the CPU circuit 3 activates the flasher circuit 5 which causes the lights of the vehicle to flash in order to identify the vehicle, the CPU 3 activates the cellular circuit 6 to send a cellular signal to a cellular tower to place a call to 911 and to activate a voice signal to instruct responders with the emergency and with the GPS location. Additionally, the flasher circuit 5 may activate the horn of the vehicle in order to draw attention to the location of the vehicle and may activate electric windows to roll down in order to reduce the inside temperature.

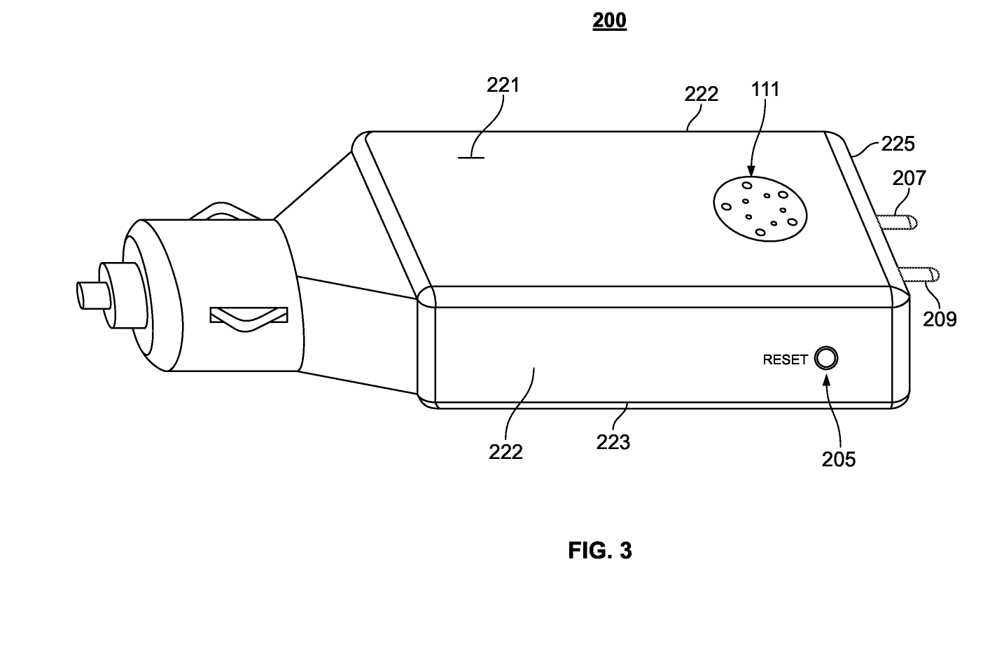

FIG. 3 illustrates the vehicle Child safety device 200 of the present invention and illustrates a generally rectangular device which may be formed from plastic, metal or other suitable material. The vehicle Child safety device 200 may include a top surface 221, an opposing bottom surface 223 which opposes the top surface 221, a pair of opposing side surfaces 222 which connect the top surface 221 and the bottom surface 223, a back surface 225 and a front surface 227 which may have a connector 229 to connect to the vehicle. The connector 229 may be an auxiliary power (12 V) connector to connect to the electrical system of the vehicle.

The top surface 227 may include a microphone 111 to obtain the level of sounds within the vehicle, a first LED light 207 which may indicate insufficient sounds within the vehicle to activate the alarms, a second LED light 209 to indicate that the sound level has surpassed a predetermined level of sounds to activate the alarms of the present invention, and a reset switch 205 to reset the device. The first LED light and the second LED light may extend out of the back surface 225, and the reset button (switch) may extend out of the side surface 222.

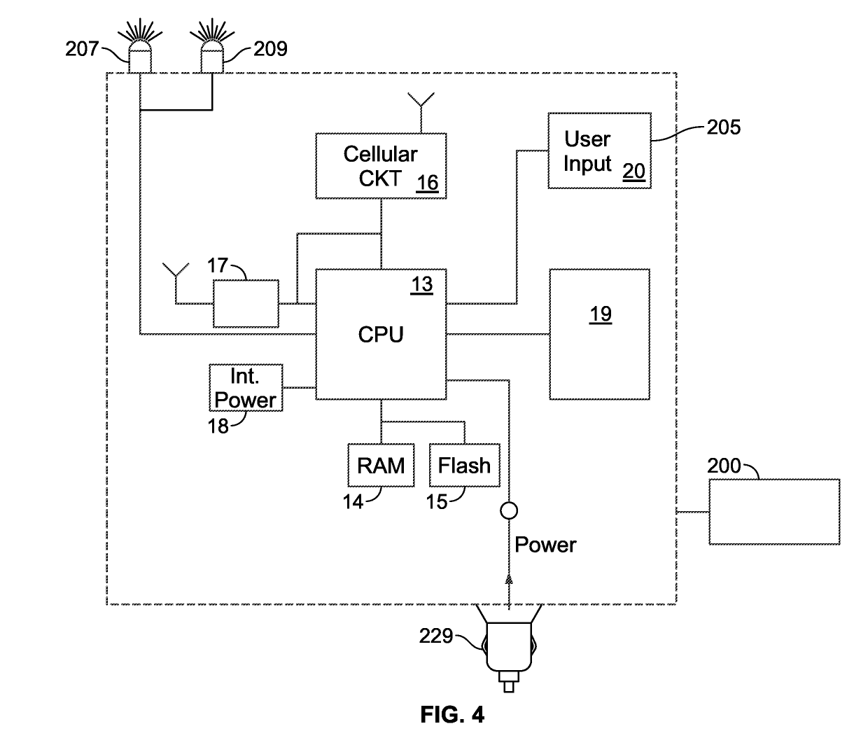

FIG. 4 illustrates a circuit diagram of the present invention and illustrates that the connector 229 is connected to the CPU circuit 13 (central processing unit circuit) which may activate either or both the first LED light 207 and the second LED light 209 to indicate various conditions such as the device 200 is activated without alarm or the device 100 is activated to an alarm condition when the sounds from the microphone 111 exceeds a predetermined level. An internal battery 18 supplies power to the CPU circuit 13 or other circuits which may require power, and the CPU circuit 13 may be connected to the reset switch 105 to allow the user to reset the CPU circuit 13. The CPU circuit 13 receives a location signal from the GPS circuit 17 (global positioning satellite circuit) to obtain the physical location of the device 100, and the physical location may be stored within the RAM circuit 14 by CPU circuit 13. After the microphone 111 receives a audible sound greater than the predetermined level, the CPU circuit 13 activates the flasher circuit 15 which causes the lights of the vehicle to flash in order to identify the vehicle, the CPU 13 activates the cellular circuit 16 to send a cellular signal to a cellular tower to place a call to 911 and to activate a voice signal to instruct responders with the emergency and with the GPS location. Additionally, the flasher circuit 15 may activate the horn of the vehicle in order to draw attention to the location of the vehicle and may activate electric windows to roll down in order to reduce the inside temperature.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A vehicle safety child device to detect a child left unattended in a vehicle, comprising:
a circuit to receive a location signal from a satellite;
a circuit to receive audio signals from the interior of a vehicle;
a circuit to connect to a control circuit of the vehicle;
a cellular circuit to activate a cellular signal to a cellular antenna;
wherein an alarm is activated when the audio signal exceeds a predetermined level.
A vehicle safety child device to detect a child left unattended in a vehicle as in claim 1, wherein the alarm is a light flasher on the vehicle.
A vehicle safety child device to detect a child left unattended in a vehicle as in claim 1, wherein the alarm is a cellular signal to broadcast the location of the vehicle.
A vehicle safety child device to detect a child left unattended in a vehicle as in claim 1, wherein the alarm activates a horn of the vehicle.
A vehicle safety child device to detect a child left unattended in a vehicle as in claim 1, wherein the first alarm activates the control circuit to roll down the windows of the vehicle.
A vehicle safety child device to detect a child left unattended in a vehicle as in claim 1, wherein a first LED light is activated when the audio signal does not exceed a predetermined level.
A vehicle safety child device to detect a child left unattended in a vehicle as in claim 1, wherein a second LED light is activated when the audio signal exceeds the predetermined level.
